(19) United States
(12) Patent Application Publication
(10) Pub. No.: US 2006/0118195 A1
(43) Pub. Date: Jun. 8, 2006

(54) High-pressure resistant vibration absorbing hose

(76) Inventors: Tetsuya Arima, Kasugai-shi (JP); Norihiko Furuta, Komaki-shi (JP); Tomohide Ito, Kasugai-shi (JP); Ayumu Ikemoto, Komaki-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/235,046

(22) Filed: Sep. 26, 2005

(30) Foreign Application Priority Data
Sep. 28, 2004 (JP) 2004-281276

(51) Int. Cl. F16L 11/00

(52) U.S. Cl. 138/126; 138/109; 138/124; 138/125

(57) ABSTRACT

A high-pressure resistant vibration absorbing hose has a hose body and a joint fitting. The joint fitting is attached to a swaged portion of the hose body. The hose body has an inner surface layer, a reinforcing layer, and an outer surface layer. The swaged portion is made to have an enlarged diameter relative to a main portion of the hose body in a state before the joint fitting is securely swaged thereto. The reinforcing layer has a braid or winding angle of a reinforcing wire member in a range of 53° to 57° at the main portion, and in a range of above 53° to 62° at the swaged portion.

### BACKGROUND OF THE INVENTION

The present invention relates to a high-pressure resistant vibration absorbing hose, specifically a high-pressure resistant vibration absorbing hose to be applied preferably for plumbing in an engine room of a motor vehicle, and a method for producing the same.

Since the past, a hose mainly composed of a tubular rubber layer has been widely used in a variety of industrial and automotive applications.

Main purpose of applying such hose is for absorption of vibration.

For example, in case of a plumbing hose to be arranged in an engine room of a motor vehicle, the plumbing hose serves as to absorb engine vibration, compressor vibration of an air conditioner (in case of a hose for conveying refrigerant, namely an air conditioning hose) and other various vibration generated during car driving, and to restrain transmission of the vibration from one member to the other member which is joined with the one member via the plumbing hose.

Meanwhile, regardless of industrial or automotive applications, hoses for an oil system, a fuel system, a water system and a refrigerant system have a multi-layered construction including an inner surface rubber layer (an inner surface layer), an outer surface rubber layer (an outer surface layer) and a reinforcing layer interposed between the inner and outer surface rubber layers, for example, as disclosed in the Patent Document No. 1 below. The reinforcing layer is constructed by braiding or spirally winding a reinforcing yarn (a reinforcing wire member).

FIG. 7 (A) shows a construction of a refrigerant conveying hose (an air conditioner hose) which is disclosed in the Patent Document No. 1 below. Reference numeral 200 in FIG. 7 (A) indicates a tubular inner surface rubber layer. A resin inner layer 202 is formed in and laminated over an inner surface of the inner surface rubber layer 200.

And, a first reinforcing layer 204 is formed or laminated on an outer side of the inner surface rubber layer 200, and a second reinforcing layer 208 is formed or laminated on an outer side of the first reinforcing layer 204 with intervening an intermediate rubber layer 206 between the first and the second reinforcing layers 204, 208. The first reinforcing layer 204 is formed by spirally winding reinforcing yarn or yarns while the second reinforcing layer 208 is formed by spirally winding reinforcing yarn or yarns in the reverse direction to the winding direction of the first reinforcing layer 204. Further, an outer surface rubber layer 210 of an outermost layer, which serves as a cover layer, is formed or laminated on an outer side of the second reinforcing layer 208.

In this example, the reinforcing layers 204, 208 are formed by spirally arranging or winding reinforcing yarns. On the other hand, such reinforcing layer is also formed by braiding reinforcing yarn or yarns.

FIG. 7 (B) shows an example of a hose having such braided reinforcing layer. Reference numeral 212 in FIG. 7 (B) indicates a reinforcing layer which is formed by braiding reinforcing yarns between the inner surface rubber layer 200 and the outer surface rubber layer 210.

Even in this example, the resin inner layer 202 is also formed in and laminated over an inner surface of the inner surface rubber layer 200.

Meanwhile, in case of such straight-sided or straight-walled tubular hose, in the past the hose has been required to have a predetermined length in order to ensure favorable vibration absorbing property.

In particular, compared to low-pressure hoses for a fuel system, water system or the like, a longer length is required for high-pressure resistant hoses for an oil system (for example, a power steering system), a refrigerant system (a refrigerant conveying system) or the like to absorb vibration and reduce transmission of noise and vibration to the vehicle interior, commensurate with rigidity of the hoses.

For example, in case of a refrigerant conveying hose, typically the hose of 300 mm to 600 mm in length is adapted to absorb vibration and reduce transmission of noise and vibration, even for plumbing or piping for direct distance of 200 mm.

However, an engine room is crammed with variety of components and parts. And, specifically in these days, an engine room has been designed in more and more compact size. Therefore, under the circumstances, if a long hose is arranged in the engine room, it bothers an design engineer to design plumbing arrangement to avoid interference with other components or parts and an operator to handle the hose when arranging the hose in the engine room. Further, such plumbing design and handling of the hose according to a type of motor vehicles should be devised. These result in excessive work load.

In view of foregoing aspects, it is demanded to develop a hose that has a short length and can absorb vibration favorably.

As for one of the means to design the hose in short length while securing vibration absorbing property, it is assumed to form the hose with corrugations.

When the hose is formed with corrugations, flexibility of the hose is drastically improved. However, once a high pressure is exerted internally to the hose by a fluid, the hose is entirely elongated largely in an axial direction.

In this instance, when the hose is in a fixed state at opposite ends thereof (usually a hose is applied in this manner), the hose is entirely curved largely and there caused a problem of interference with other components and parts around the hose.

As a conclusion, it is not a sufficient countermeasure to provide the hose with corrugations.

Meanwhile, in case of a high-pressure resistant hose such as an air conditioning hose, when a high pressure is exerted to the hose by a fluid directed in the inside thereof, the hose and the fluid work together, the hose thereby exhibits the rigid-body like behavior much more than when such high pressure is not exerted to the hose.

The larger the cross-sectional area of the hose including the fluid is, the greater the degree of the rigidity is.

That is, the smaller the cross-sectional area of the hose including the fluid is, the less the degree of the rigidity is, resulting that the vibration absorbing property is increased by just that much.

Therefore, in order to design a hose non-corrugated and short in length while enhancing vibration absorbing property of the hose, it is effective means to form the hose with a small diameter.

However, if a hose is formed just with a small diameter entirely including axial end portions of the hose, and in addition, a joint fitting is formed also with a small diameter, an insert pipe to be adapted in the joint fitting must be formed also with a small inner diameter. Therefore, resultantly, pressure loss is caused on the portion of the joint fitting during transporting fluid or a required flow amount cannot be secured in such hose.

On the other hand, if a hose or hose body is formed with a small diameter at a swaged portion on an axial end portion of the hose and a large diameter joint fitting having an insert pipe with a large inner diameter is applied, insertion resistance is extremely increased when the insert pipe is inserted in the swaged portion on the axial end portion for attachment of the joint fitting, and insertability of the insert pipe is impaired. Therefore, it is virtually difficult to attach the joint fitting to the swaged portion.

So, if a hose is intended to be formed with a small diameter, it is preferred that only a main portion other than the swaged portion is formed with a small diameter without forming the swaged portion on the axial end portion with a small diameter.

In this case, the swaged portion on the axial end portion relatively has an enlarged diameter or larger diameter relative to the main portion.

As for measure to produce such hose having the enlarged diameter or larger diameter on the axial end portion, it is assumed to form first an unvulcanized hose body in a straight-walled cylindrical shape, then diametrically enlarge or deform only the axial end portion thereof, and vulcanize the unvulcanized hose body.

For example, the following Patent Documents No. 2 and No. 3 disclose water system hoses such as a radiator hose. Each of the patent documents discloses that an unvulcanized hose body is formed by extrusion, a mandrel is inserted in an axial end portion of the unvulcanized hose body, then the unvulcanized hose body is vulcanized and formed with the mandrel therein to diametrically enlarge the axial end portion of the hose body.

In such water system hose as disclosed in the Patent Documents 2 and 3, a bursting pressure is small and braid or winding density of a reinforcing layer is low, about 15 to 25%. In this case, the difficulty lies not so much in diametrically enlarging the axial end portion of the hose body. However, in a high density and high-pressure resistant hose that has a bursting pressure equal to or larger than 5 MPa and includes a reinforcing layer with a braid or winding density equal to or larger than 50%, resistance by the reinforcing layer is remarkably increased when the mandrel is inserted in the axial end portion, and diametrically enlarging work is made abruptly difficult.

Such matters are hereinafter studied more specifically. In both a low-pressure resistant hose such as a hose for a water system and a high-pressure resistant hose including a reinforcing layer of a high braid or winding density, the braid or winding angle of the reinforcing yarn in the reinforcing layer is usually made or designed around a neutral angle (54.7°).

The reason is as follows: For example, in the reinforcing layer having a winding or braid angle of a reinforcing yarn higher than a neutral angle, when an internal pressure is exerted to the hose, the reinforcing layer is subject to the internal pressure, and the reinforcing layer entirely expands or elongates longitudinally (contracts and deforms in a radial direction) so as to make the braid or winding angle of a reinforcing yarn close to or to be a neutral angle as shown in FIG. 8 (a). Namely, the hose is deformed so as to be increased in length. On the contrary, as shown in FIG. 8 (c), in the reinforcing layer having a winding or braid angle lower than the neutral angle, the reinforcing layer expands and deforms in a radial direction (contracts and deforms in a longitudinal direction) so as to make the braid or winding angle thereof close to or to be the neutral angle when an internal pressure is exerted thereto. Namely, the hose itself is expanded and deformed so as to be increased in diameter. However, in the reinforcing layer made to have a braid or winding angle equal to or around the neutral angle, the hose may be prevented or restrained from deformation in the longitudinal direction and in the radial direction even when an internal pressure is exerted thereto as shown in FIG. 8 (b).

However, when the braid or winding angle of the reinforcing yarn in the reinforcing layer is made or designed equal to or around the neutral angle, specifically in the case of such high-density and high-pressure resistant hose including the reinforcing layer having the braid or winding density equal to or larger than 50% and bursting pressure equal to or larger than 5 MPa, diametrically enlarging work becomes difficult when the mandrel is inserted in the axial end portion of the hose or the hose body.

[Patent Document No.1] JP-A, 7-68659

[Patent Document No. 2] JP-B, 3244183

[Patent Document No.3] JP-B, 8-26955

Under the circumstances described above, it is an object of the present invention to provide a novel high-pressure resistant vibration absorbing hose with good vibration absorbing property, wherein a joint fitting is securely swaged on an axial end portion thereof, and a novel method for producing the high-pressure resistant vibration hose. In the novel high-pressure resistant vibration absorbing hose, the required flow volume of a fluid can be secured during conveying the fluid. The novel high-pressure resistant vibration absorbing hose may include a swaged portion or a swaged area with good swaging property.

### SUMMARY OF THE INVENTION

According to the present invention, there is provided a novel high-pressure resistant vibration absorbing hose that comprises a hose body and a joint fitting. The hose body has an inner surface layer, a reinforcing layer that is formed on an outer side of the inner surface layer by braiding or spirally winding a reinforcing wire member and an outer surface layer as a cover layer on an outer side of the reinforcing layer. The reinforcing layer has a high braid or winding density of the reinforcing wire member of 50% or more. The hose body has a swaged portion (to-be-swaged portion) on an axial end portion of the hose body and a main portion other than the swaged portion. The joint fitting is attached to the swaged portion of the hose body, and has a rigid insert pipe and a sleeve-like socket fitting. The joint fitting is securely fixed to the swaged portion by securely swaging the socket fitting to the swaged portion in a diametrically contracting direction while the insert pipe is inserted within the swaged portion and the socket fitting is fitted on an outer surface of the swaged portion. A bursting pressure of the high-pressure resistant vibration absorbing hose is 5 MPa or more. The swaged portion of the hose body is made or designed to have an enlarged diameter or a larger diameter relative to the main portion of the hose body in a state before the joint fitting is securely swaged to the swaged portion. The reinforcing layer has a braid or winding angle of the reinforcing wire member in a range from 53° to 57° at a position or in an area of the main portion, and in a range of above 53° to 62°, for example, in a range of above the neutral angle to 62° at a position or in an area of the swaged portion of the enlarged diameter, for example, in a state before the joint fitting is securely swaged to the swaged portion.

Here, the braid or winding density means a ratio of an area of the reinforcing wire member to an area of the reinforcing layer. When the reinforcing wire member is arranged without clearance or with zero clearance, the braid density or winding density is 100%.

The braid or winding angle is an angle of orientation of the reinforcing wire member with respect to an axis of the hose body, or an angle of inclination of the reinforcing wire member relative to the axis of the hose body.

Each of the inner surface layer, the reinforcing layer and the outer surface layer also has a swaged portion (to-be-swaged portion) and a main portion corresponding to the swaged portion and the main portion of the hose body.

Also according to the present invention, there is provided a novel method for producing a high-pressure resistant vibration absorbing hose, for example, as defined in claim 1 or 2. The method for producing the high-pressure resistant vibration absorbing hose comprises (a) a step of forming a hose body, for example, an unvulcanized hose body (for example, of a straight-walled cylindrical shape) laminated with an inner surface rubber layer as the inner surface layer, a reinforcing layer formed by braiding or spirally winding a reinforcing wire member (for example, reinforcing yarn) at a braid or winding angle in a range of 53° to 57° and an outer surface rubber layer as an outer surface layer, (b) a step of diametrically enlarging an axial end portion of the hose body or the unvulcanized hose body by force fitting a mandrel or mandrel mold therein and thereby increasing the braid or winding angle of the reinforcing wire member in the reinforcing layer within a range of above 53° to 62°, for example, in a range of above neutral angle to 62°, at the axial end portion, and (c) a step of heating the hose body or heating and vulcanizing the unvulcanized hose body while maintaining the axial end portion of the hose body in diametrically enlarged state.

In the method for producing the high-pressure resistant vibration absorbing hose according to the present invention, the mandrel may be force fitted in the axial end portion of the hose body in which an outer surface of the main portion is retained and restrained by a retaining member, so as to diametrically enlarge the axial end portion. The retaining member may have a cylindrical inner surface, for example, with an inner diameter equal to or generally equal to an outer diameter of the unvulcanized hose body of a straight-walled cylindrical shape or the main portion of the unvulcanized hose body.

In the method for producing the high-pressure resistant vibration absorbing hose according to the present invention, further, the mandrel may be force fitted inside the axial end portion of the hose body while an internal pressure is exerted in the hose body. Here, the internal pressure may be exerted in the hose body by way of a pressurizing fluid path running axially through the mandrel.

As stated above, the high pressure resistance vibration absorbing hose according to the present invention includes the reinforcing layer having a high braid or winding density of 50% or more, and the joint fitting that is securely swaged on the swaged portion of the hose body on the axial end thereof. The bursting pressure of the high-pressure resistant vibration absorbing hose is 5 MPa or more. The swaged portion or the to-be swaged portion of the hose body is made or designed to have an enlarged diameter or a larger diameter relative to the main portion other than the swaged portion, in a state before the joint fitting is securely swaged thereto. The reinforcing layer has the braid or winding angle of the reinforcing wire member in the range from 53° to 57° at the position of the main portion, and in the range of above 53° to 62° at the position of the swaged portion of the enlarged diameter.

In the hose body of the high-pressure resistant vibration absorbing hose of the present invention, the swaged portion of the hose body on the axial end portion is made to have an enlarged diameter relative to the main portion in a state before the joint fitting is securely swaged thereto. This allows to easily attach the joint fitting to the swaged portion, and to effectively reduce or eliminate the difference of inner diameter between the insert pipe of the joint fitting and the main portion of the hose body. Thereby it may be restrained to cause pressure loss in an area of the joint fitting during conveying a fluid and it is possible to easily secure a required flow volume in such hose

And, according to the present invention, at the main portion of the hose body that serves a major part of absorbing vibration, a braid or winding angle of the reinforcing layer, specifically the braid or winding angle of the reinforcing wire member is limited within a range of the neutral angle plus or minus about 2°, namely from the neutral angle minus about 2° to the neutral angle plus about 2°. This may favorably restrain the hose from deformation in a longitudinal direction and a radial direction under high internal pressure exerted during conveying the fluid.

On the other hand, at the swaged portion on the axial end portion of the reinforcing layer, the braid or winding angle of the reinforcing wire member is made or designed above 53°, and thereby favorable swaging property is achieved when the joint fitting is securely swaged to the swaged portion.

The inventors of the present invention obtained a finding that even when the braid or winding angle of the reinforcing wire member at the swaged portion is above 53°, it is possible to diametrically enlarge an axial end portion by force-fitting a mandrel therein. Further, the inventors obtained an important finding that an increased braid or winding angle of the reinforcing wire member at the swaged portion contrarily improve swaging property.

That is, the inventors obtained a finding that when the braid or winding angle of the reinforcing wire member is increased at the swaged portion, a retaining force or joint force (resistance to pull force) of the joint fitting becomes larger, and simultaneously the bursting pressure becomes higher.

This is attributed to as follows. In case where the braid or winding angle is made high, specifically as high as above the neutral angle, when a high internal pressure is exerted by a fluid, the swaged portion and the reinforcing layer therein diametrically contract, namely are deformed so as to be narrowed toward an axial center, while elongating in an axial direction, a contact strength or joining force between the joint fitting and the swaged portion is increased, and the retaining force of the joint fitting is increased. And, due to increased braid or winding angle, the braid or winding density is partially increased and the bursting pressure is raised. In this point of view, the braid or winding angle of the reinforcing wire member on the axial end portion, namely on the swaged portion is preferably made above the neutral angle, 54.7°, more specifically, equal to or higher than 57°. In this point of view, the braid or winding angle of the reinforcing wire member on the axial end portion, namely on the swaged portion is preferably made above the neutral angle of 54.7°, more specifically, equal to or higher than 57°.

However, in case where the braid or winding angle of the reinforcing wire member at the swaged portion is made larger than a certain angle, insertability of the mandrel is remarkably impaired when the axial end portion is diametrically enlarged by inserting the mandrel therein, and actually diametrically enlarging work is made difficult.

In this point of view, the braid or winding angle at the swaged portion is limited to 62° at maximum.

Meanwhile, a wall thickness of the inner surface layer is preferably made or designed equal to or larger than 1.0 mm at the swaged portion after diametrically enlarged.

Thereby it may be favorably prevented that breakage is caused at the swaged portion in the inner surface layer when the joint fitting is securely swaged to the swaged portion.

As already stated, the method for producing the high-pressure resistant vibration absorbing hose in particular defined in claim 1 or 2, or, for example, defined in claim 1 or 2, according to the present invention, comprises a step of forming an hose body laminated with an inner surface rubber layer as an inner surface layer, a reinforcing layer formed by braiding or spirally winding the reinforcing wire member at a braid or winding angle in a range of 53° to 57°, and an outer surface rubber layer as an outer surface layer, a following step of diametrically enlarging an axial end portion of the hose body by force fitting a mandrel therein, and thereby increasing the braid or winding angle of the reinforcing wire member in the reinforcing layer to high angle or higher angle within a range of above 53° to 62° at the axial end portion, and a yet following step of heating the hose body while maintaining the axial end portion thereof in diametrically enlarged state. In this method, the high-pressure resistant vibration absorbing hose, for example, as defined in claim 1 or 2 may be easily obtained.

In the above method for producing the high pressure vibration absorbing hose, a mandrel may be force fitted in the axial end portion of the hose body so as to diametrically enlarge the axial end portion while an outer surface of the main portion of the hose body is retained and restrained by a retaining member. According to this method, as the outer surface of the main portion is retained and restrained by the retaining member when the mandrel is force fitted to and inside the axial end portion to diametrically enlarge the axial end portion, it may be favorably prevented that buckling of the axial end portion is caused by fitting force or push-in force of the mandrel in the axial direction, and therefore the axial end portion may be favorably diametrically enlarged.

When the reinforcing layer has the high braid or winding density of the reinforcing wire member equal to or larger than 50% in order to provide the hose with high pressure resistance, a large resistance is exerted to the mandrel by the reinforcing layer when the mandrel is force fitted to and inside the axial end portion to diametrically enlarge the axial end portion. So, when the mandrel is force fitted, a problem of axial buckling of the axial end portion tends to occur. However, according to one aspect of the present invention, the mandrel may be smoothly force fitted inside the axial end portion thanks to retaining and restraining action by the restraining member without such problem and thereby the axial end portion may be favorably diametrically enlarged.

According to one aspect of the method for producing the high-pressure resistant vibration absorbing hose of the present invention, the mandrel is force fitted in the axial end portion while radially expanding force is exerted in the hose body by applying an internal pressure in the hose body. Thereby the axial end portion may be more easily diametrically enlarged by force fitting or pushing of the mandrel.

The inner surface layer is provided, for example, as an innermost layer. However, depending on the circumstances, a resin layer or the like may be provided in or inside the inner surface layer.

Now, the preferred embodiments of the present invention will be described in detail with reference to the drawings.

### BRIEF DESCRIPTION OF THE DRAWINGS

FIG. 1 (A) is a view showing a hose according to one embodiment of the present invention.

FIG. 1 (B) is a perspective view showing a multi-layered construction of a part B of FIG. 1 (A).

FIG. 2 is an enlarged sectional view showing an axial end portion of the hose according to the one embodiment.

FIG. 3 (A) is a view of a hose body of FIG. 1(A).

FIG. 3 (B) is an enlarged view of a part B of FIG. 3 (A).

FIG. 4 (A) is a sectional view of the hose body of FIG. 1 in a state before an axial end portion thereof is diametrically enlarged.

FIG. 4 (B) is a front view of the hose body of FIG. 1 in the state before the axial end portion thereof is diametrically enlarged.

FIG. 5 (A) is a view showing a state before a mandrel is inserted in the hose body of FIG. 4 (A).

FIG. 5 (B) is a view showing a state that the axial end portion of the hose body of FIG. 4 (A) is diametrically enlarged by force fitting the mandrel therein.

FIG. 5 (C) is a view showing a state that the hose body is heated.

FIG. 6 (A) is a view showing a state before another mandrel is inserted in the hose body of FIG. 4 (A).

FIG. 6 (B) is a view showing a process of force fitting the another mandrel in the hose body of FIG. 4 (A).

FIG. 7 (A) is a view showing one type of a conventional hose.

FIG. 7 (B) is a view showing another type of a conventional hose.

FIG. 8 is an explanatory view showing a relationship between a braid or spirally winding angle and deformation of a reinforcing layer.

### DETAILED DESCRIPTIONS OF PREFERRED EMBODIMENTS

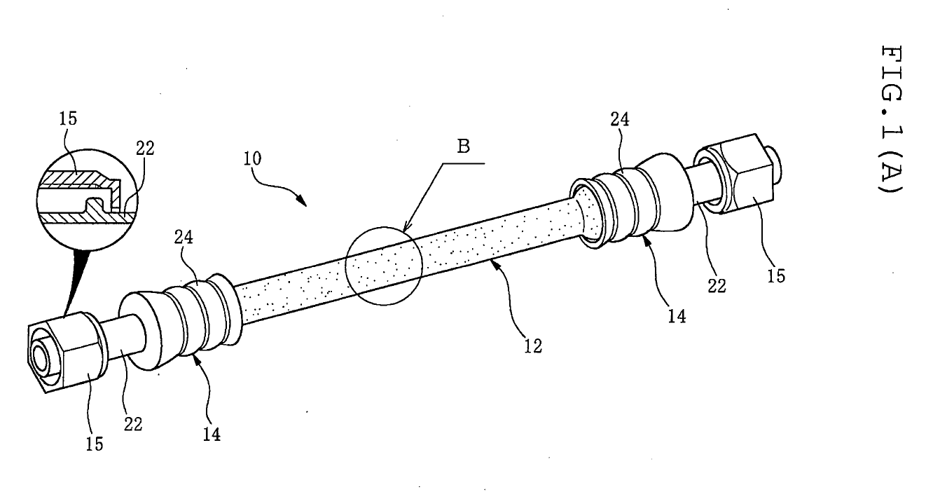

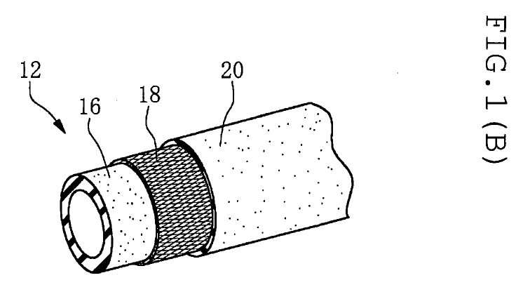

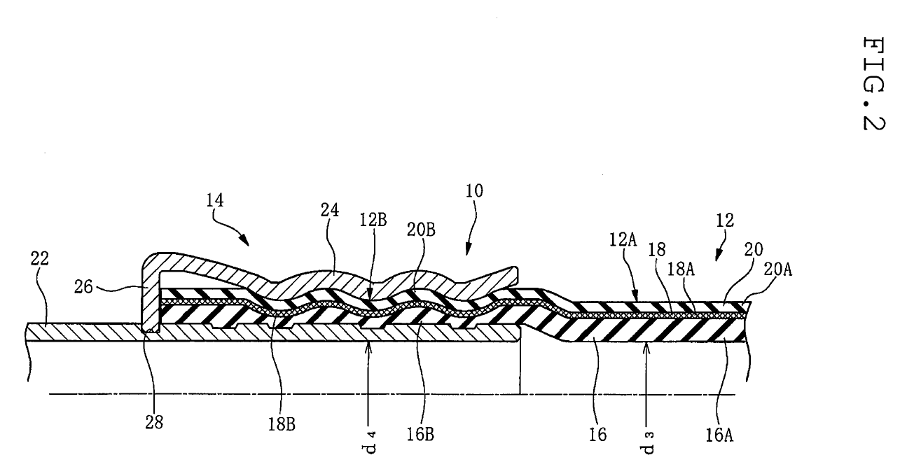

In FIGS. 1 (A) and (B), reference numeral 10 indicates a high-pressure resistant vibration absorbing hose (hereinafter simply referred to as a hose), which is applied, for example, as a refrigerant conveying hose (air conditioning hose) or the like, has a hose body 12 and a pair of joint fittings 14 which are securely swaged or compressed on swaged or compressed portions 12B on axial end portions thereof (refer to FIG. 2).

As shown in FIG. 2, the hose body 12 has a multi-layered construction, an inner rubber layer or inner surface rubber layer (inner surface layer) 16 of an innermost layer, a reinforcing layer 18 that is formed by braiding a reinforcing yarn or reinforcing filament member (reinforcing wire member) on an outer side of the inner surface rubber layer 16, and an outer rubber layer or outer surface rubber layer (outer surface layer) 20 of an outermost layer as a cover layer. The reinforcing layer 18 may be also formed by spirally winding the reinforcing yarn or reinforcing filament member.

For the reinforcing yarn or filament member forming the pressure resistant reinforcing layer 18, polyethylene terephthalate (PET), polyethylene naphthalate (PEN), aramid, polyamide or nylon (PA), vynilon, rayon, metal wire or the like may be adapted.

The inner surface rubber layer 16 may be formed from isobutylene-isoprene rubber (IIR), halogenated IIR (chloro-IIR (Cl-IIR or CIIR), bromo-IIR (Br-IIR or BIIR)), acrylonitrile-butadiene-rubber (NBR), chloroprene rubber (CR), ethylene-propylene-diene-rubber (EPDM), ethylene-propylene copolymer (EPM), fluoro rubber or fluorinated rubber (FKM), epichlorohydrin rubber or ethylene oxide copolymer (ECO), silicon rubber, urethane rubber, acrylic rubber or the like. These materials are applied in single or blended form for the inner surface rubber layer 16.

However, in case where the hose 10 is applied for hydrofluorocarbon (HFC) type refrigerant conveying hose, specifically IIR or halogenated IIR in single or blended form may be preferably used.

The outer surface rubber layer 20 may be formed also from every kind of rubber materials cited above as material for the inner surface rubber layer 16. In addition, heat-shrinkable tube and thermoplastic elastomer (TPE) are also applicable for the outer surface rubber layer 20. As for material of such heat-shrinkable tube and TPE, acrylic type, styrene type, olefin type, diolefin type, polyvinyl chloride type, urethane type, ester type, amide type, fluorine type or the like may be applied.

As shown in FIG. 2, the above joint fitting 14 has a rigid metal insert pipe 22 and a sleeve-like socket fitting 24. The insert pipe 22 is inserted in the swaged portion 12B of an axial end portion of the hose body 12, the socket fitting 24 is fitted on an outer surface of the swaged portion 12B. Then, the socket fitting 24 is swaged in a diametrically contracting direction, and securely swaged on the swaged portion 12B. The joint fitting 14 is thereby securely swaged on the hose body 12 while the swaged portion 12B is clamped in an inward and outward direction by the socket fitting 24 and the insert pipe 22.

Here, the socket fitting 24 includes an inwardly directed annular stop portion 26. An inner peripheral end portion of the stop portion 26 is fitted and stopped in an annular stop groove 28 in an outer peripheral surface of the insert pipe 22.

Reference numeral 15 in FIG. 1 (A) indicates a hexagon cap nut or a mounting nut that is rotatably mounted on the insert pipe 22.

As shown in FIG. 2, in this embodiment, an inner diameter of a main portion 12A of the hose body 12, specifically an inner diameter d₃ of the inner surface rubber layer 16 at the main portion 12A (a main portion 16A of the inner surface rubber layer 16) and an inner diameter d₄ of the insert pipe 22 are made or designed identical.

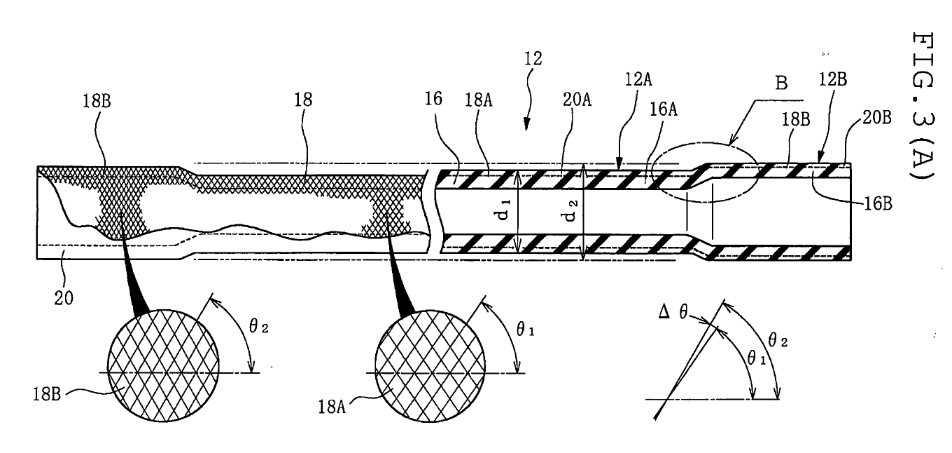

FIG. 3 (A) shows a shape of the hose body 12 before the joint fitting 14 is securely swaged thereto.

In FIG. 3 (A), reference numeral 12A indicates the main portion of the hose body 12, and reference numeral 12B indicates a swaged portion or to-be-swaged portion on an axial end portion thereof. As shown in FIG. 3 (A), in this embodiment, an outer diameter d₁ of the main portion 12A is smaller than an outer diameter d₂ of the swaged portion 12B. An inner diameter of the main portion 12A is smaller than an inner diameter of the swaged portion 12B.

That is, in a conventional hose of this type, an outer diameter of a main portion 12A of a hose body 12 is made the same as an outer diameter of a swaged portion 12B thereof. However, in this embodiment, only the main portion 12A is formed with smaller diameter.

As a result, the swaged portion 12B is larger in diameter than the main portion 12A, or diametrically enlarged with respect to the main portion 12A.

In FIG. 3 (A), reference numeral 16A indicates a main portion of the inner surface rubber layer 16 and reference numeral 16B indicates a swaged portion or to-be-swaged portion thereof (the inner surface rubber layer 16 at the swaged portion 12B). Reference numeral 18A indicates a main portion of the reinforcing layer 18 (the reinforcing layer 18 at the main portion 12A) and reference numeral 18B indicates a swaged portion or to-be-swaged portion thereof (the reinforcing layer 18 at the swaged portion 12B).

Further, numeral reference 20A indicates a main portion of the outer surface rubber layer 20 (the outer surface rubber layer 20 at the main portion 12A), and 20B indicates a swaged portion or to-be-swaged portion thereof (the outer surface rubber layer 20 at the swaged portion 12B).

In this embodiment, as shown in FIG. 3 (A), in the reinforcing layer 18, a braid angle θ₁ of the reinforcing yarn is within a range of 53° to 57° at the main portion 18A, while a braid angle θ₂ of the reinforcing yarn is higher than θ₁ and within a range of above 53° to 62° at the swaged portion 18B of enlarged diameter in a state before the joint fitting 14 is securely swaged to the swaged portion 12B.

As shown in FIG. 3 (B), in the inner surface rubber layer 16, a wall thickness t₂ of the swaged portion 16B is smaller than a wall thickness t₁ of the main portion 16A. However, the wall thickness t₂ is equal to or larger than 1.0 mm.

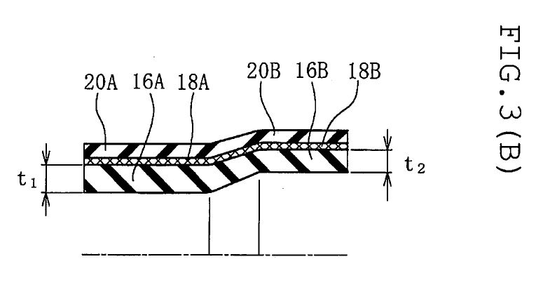

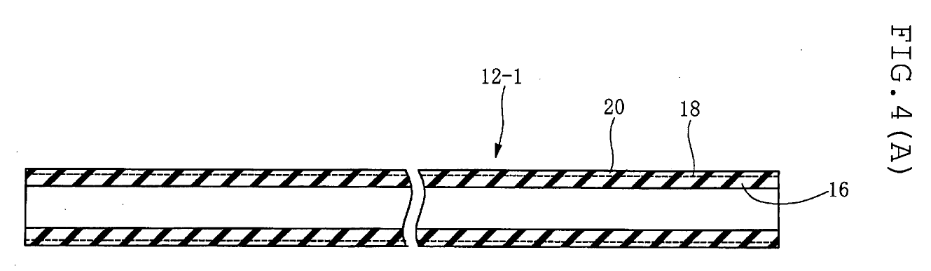

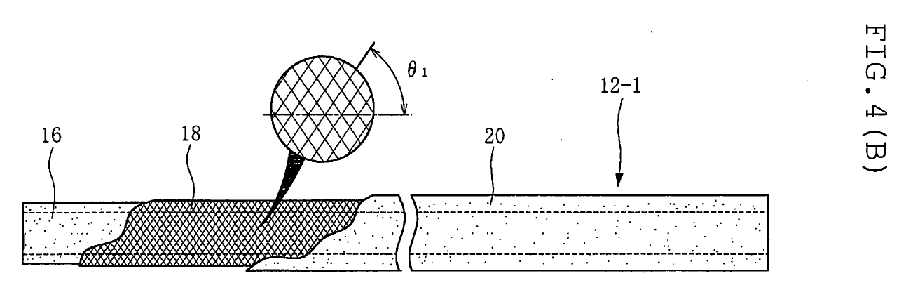

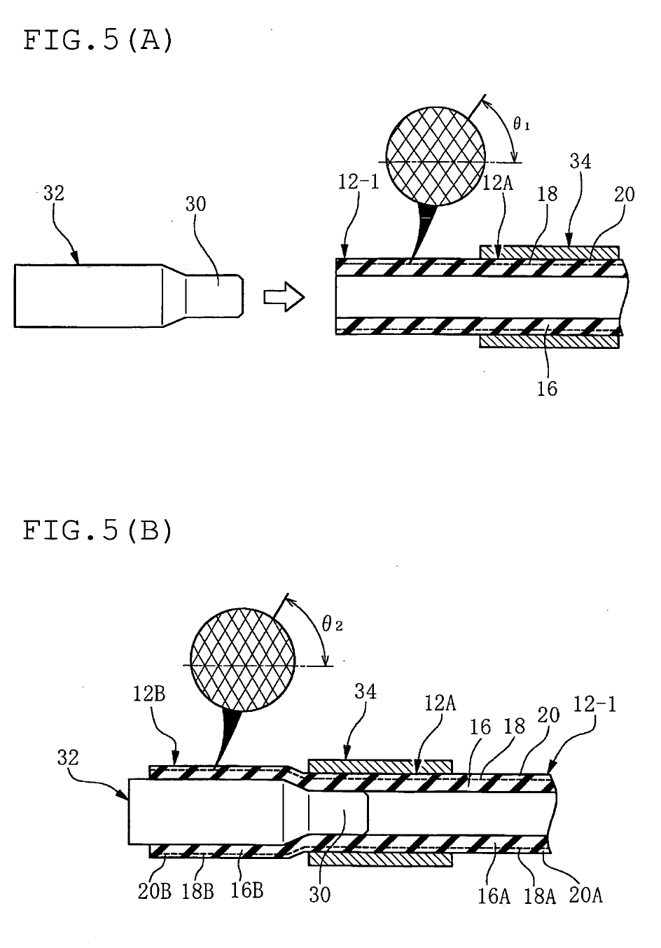

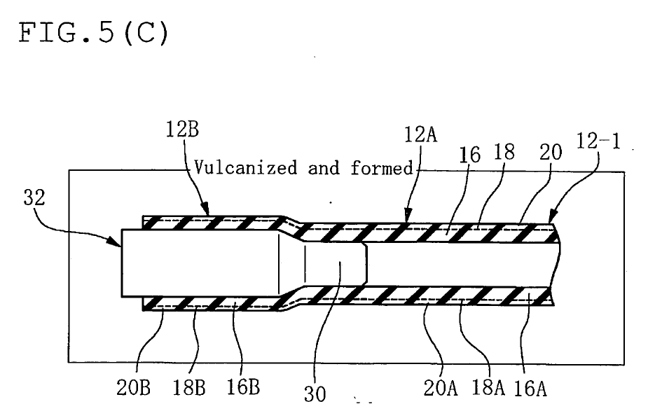

FIGS. 4 and 5 show a method for producing the hose 10 according to this embodiment. As shown in FIG. 4, in this method for producing the hose 10, first, the inner surface rubber layer 16, the reinforcing layer 18 and the outer surface rubber layer 20 are laminated on one another in this order and thereby formed is an unvulcanized hose or hose body 12-1 of straight-walled cylindrical shape.

A braid angle of a reinforcing yarn or filament member in the reinforcing layer 18 here is the same as a braid angle θ₁ of the reinforcing yarn or filament member in the main portion 18A shown in FIG. 5(B).

Then, as shown in FIG. 5 (A), the unvulcanized hose body 12-1 is diametrically enlarged or deformed at an axial end portion thereof by means of a mandrel 32 that has a large diameter portion and a small diameter portion 30 on a leading end of the large diameter portion thereof. In the mandrel 32, the large diameter portion has an outer diameter larger than an inner diameter of the unvulcanized hose body 12-1 of a straight-walled cylindrical shape, while the small diameter portion 30 has an outer diameter identical to or generally identical to the inner diameter of the unvulcanized hose body 12-1 of a straight-walled cylindrical shape.

At this time, a retaining mold or retaining member 34 of cylindrical shape is also used for diametrically enlarging the unvulcanized hose or hose body 12-1. Specifically, while the retaining member 34 of cylindrical shape is fitted on the main portion 12A of the unvulcanized hose body 12-1 to retain and restrain an outer surface thereof, the mandrel 32 is force fitted axially to and inside the axial end portion thereof. Thereby the axial end portion of the unvulcanized hose body 12-1 is diametrically enlarged in a shape corresponding to a shape and an outer diameter of the mandrel 32. The mandrel 32 is force fitted or pushed in the unvulcanized hose body 12-1 until the large diameter portion of the mandrel 32 enters in the axial end portion of the hose body 12-1 and the small diameter portion 30 thereof enters in the retaining member 34. In the reinforcing layer 18, the original braid angle θ₁ of the reinforcing yarn at an axial end portion thereof, namely the swaged portion 18B is increased by diametrically enlarging the axial end portion, to be θ₂, higher than θ₁ (refer to FIGS. 3 (A), 5 (A) and 5 (B)).

During that time, the main portion 12A is retained and restrained by the restraining member 34. Therefore, even in case that the mandrel 32 is force fitted in the unvulcanized hose body 12-1 by overcoming resistance of the reinforcing layer 18 (specifically, the swaged portion 18A in the reinforcing layer 18) in a diametrically enlarging direction, the axial end portion is favorably diametrically enlarged by the mandrel 32 without causing buckling of the axial end portion.

After the axial end portion is diametrically enlarged, a wall thickness of the swaged portion 16B of the inner surface rubber layer 16 becomes small due to diametrical enlargement of the axial end portion. However, as stated above, the wall thickness t₂ of the swaged portion 16B is secured 1.0 mm or larger after the diametrical enlargement.

In other words, a wall thickness of the inner surface rubber layer 16, specifically the wall thickness t₁ of the main portion 16A is determined such that the wall thickness t₂ of the swaged portion 16B thereof is equal to or larger than 1.0 mm after the axial end portion is diametrically enlarged at a predetermined diametrically enlarging rate by insertion of the mandrel 32.

After the axial end portion is diametrically enlarged by insertion of the mandrel 32 as described above, the unvulcanized hose body 12-1 is heated and vulcanized with the mandrel 32 therein (FIG. 5 (C)).

And, after the heating and vulcanizing process of FIG. 5 (C) is completed, the mandrel 32 is removed, and the joint fitting 14 is securely swaged on the swaged portion 12B of the hose body 12 that is diametrically enlarged.

Thereby the hose 10 as shown in FIG. 1 is obtained.

In the inner surface rubber layer 16 of this embodiment, the main portion 16A is made to have the wall thickness t₁ required for providing the hose 10 with favorable vibration absorbing property, and on the other hand, required for providing the hose 10 with impermeability to internal fluid or water impermeability.

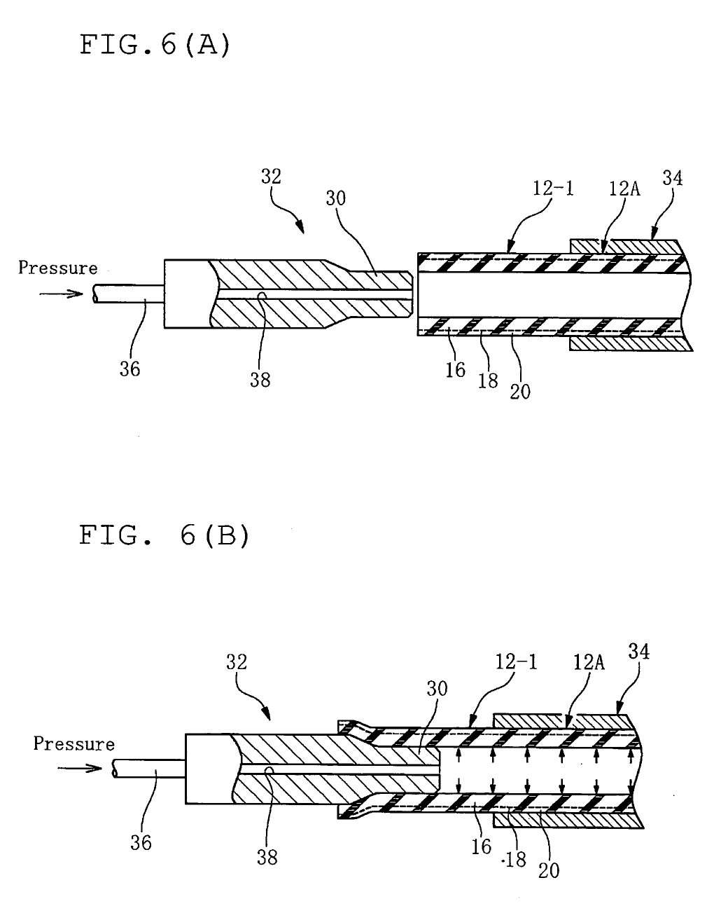

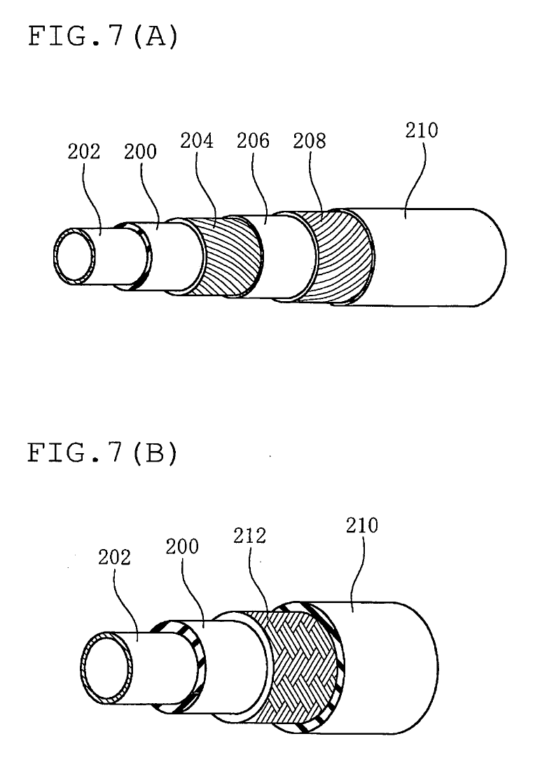

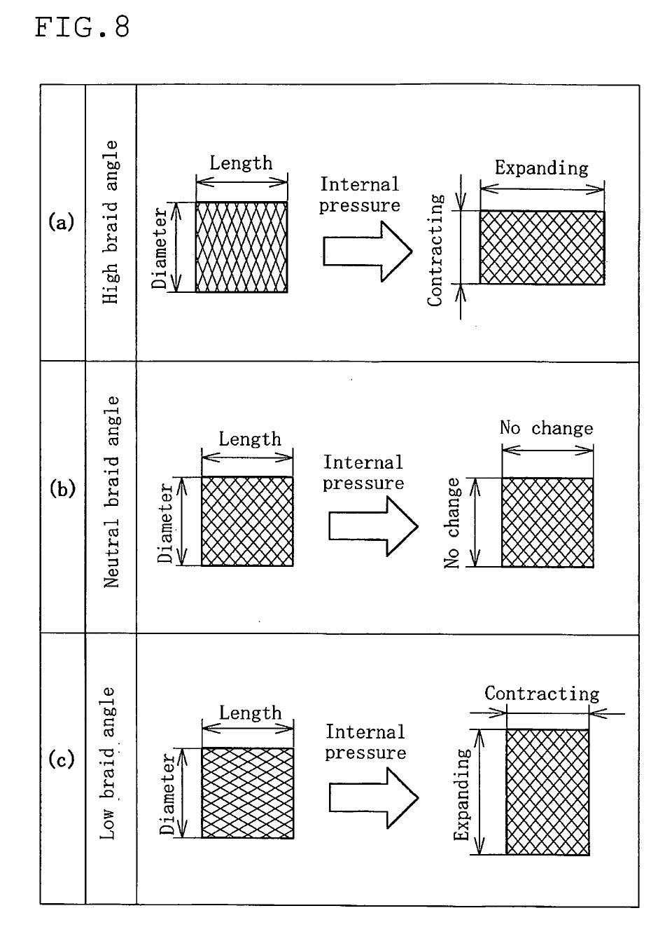

In FIG. 5, the mandrel 32 is just force fitted and inserted in the axial end portion of the unvulcanized hose body 12-1. However, if the mandrel 32 is hard to be force fitted therein due to the resistance of the reinforcing layer 18, the mandrel 32 may be provided with a tube or tube body 36, while a path or fluid path (pressurizing fluid path) 38 is formed so as to run axially through the mandrel 32 as shown in FIG. 6. Then, a pressurizing fluid may be introduced inside the unvulcanized hose body 12-1 through a tube body 36 and the fluid path 38. In this manner, while an internal pressure is exerted inside the unvulcanized hose body 12-1, the mandrel 32 may be force fitted and inserted in the unvulcanized hose body 12-1.

For example, it is relatively easy to force fit the mandrel 32 in the unvulcanized hose body 12-1 when the axial end portion is diametrically enlarged at a diametrically enlarging rate within 10%. However, the diametrically enlarging rate exceeding 10% sometimes makes it difficult to force fit the mandrel 32 in the unvulcanized hose body 12-1 without specific means. In this case, the mandrel 32 with the fluid path 38 may be applied. And, while the internal pressure is exerted inside the unvulcanized hose body 12-1 through the fluid path 38 from the tube body 36, the mandrel 32 may be inserted therein. By exerting the internal pressure therein the mandrel 32 may be inserted therein smoothly or more smoothly.

As stated above, in the hose body 12 of this embodiment, the swaged portion 12B of the hose body 12 is made to have a larger diameter than the main portion 12A of the hose body 12 in a state or shape before the joint fitting 14 is securely swaged thereto. So, this allows to easily mount the joint fitting 14 to the swaged portion 12B, and to make the insert pipe 22 of the joint fitting 14 equal in inner diameter to the main portion 12A of the hose body 12. This may restrain pressure damage in an area of the joint fitting 14 during conveying fluid, and easily secure required flow volume.

And, in the reinforcing layer 18 of the present embodiment, a braid angle, specifically a braid angle of the reinforcing yarn at the main portion 12A that serves a major part of absorbing vibration is limited within a range of a neutral angle plus or minus about 2°. This may restrain the hose 10 from deformation in a longitudinal direction and a radial direction under high internal pressure exerted during conveying fluid.

On the other hand, the braid angle of the reinforcing yarn is designed above 53° at the swaged portion 18B, an axial end portion in the reinforcing layer 18, and thus favorable swaging property is achieved in the area of/in the joint fitting 14 after the joint fitting 14 is securely swaged to the swaged portion 18B.

And, according to the method for producing the high-pressure resistant vibration absorbing hose of the present embodiment, above-mentioned high-pressure resistant vibration absorbing hose 10 may be produced easily.

### EXAMPLE

Some example and comparison example hoses are formed or produced having different constructions as shown in Table 1, and each of the hoses is measured and evaluated with respect to swaging property of a swaged portion or swaged area (in joint fitting pull-out force, namely a force required to pull out a joint fitting and bursting pressure at high temperature), length change (or elongation rate) under pressure exerted, and insertability of mandrel (namely, workability of inserting a mandrel in an axial end portion of a hose body).

Here, a joint fitting is securely swaged to a hose body at swaging rate of 35%.

In the line “No. of yarns” of the reinforcing layer of each of example and comparison example hoses in Table 1, “3 parallel yarns×48 carriers” means that 3 parallel reinforcing yarns of 1000 denier (de) are braided on a 48 carrier machine. In Table 1, the joint fitting pull-out force and the bursting pressure at high temperature are measured under the following conditions, respectively.

[Joint Fitting Pull-Out Force]

The joint fitting is pulled at speed or pulling speed of 10 mm/minute and measured is pull-out force when the joint fitting 14 is pulled out of the hose body.

[Bursting Pressure at High Temperature]

Each of the example and comparison example hoses is attached to a bath containing oil of 100° C. and is let stand for 30 minutes. Then a pressure is exerted to the hose while being kept for 30 seconds at every pressure raised by 0.98 MPa and recorded is a pressure when the hose bursts.

TABLE 1

| | | | Examples | | | | |
|---|---|---|---|---|---|---|---|
| | | | 1 | 2 | 3 | 4 | |
| Main | Dimension | Inner | diameter | diameter | diameter | diameter | |
| portion | (mm) | diameter | 9.0 | 9.0 | 9.0 | 9.0 | |
| of hose | | Outer | diameter | diameter | diameter | diameter | |
| body | | diameter | 16.0 | 16.0 | 16.0 | 16.0 | |
| | Inner | Material | Cl-IIR | Cl-IIR | Cl-IIR | Cl-IIR | |
| | surface | Wall | 2.0 | 2.0 | 2.0 | 2.0 | |
| | layer | thickness | | | | | |
| | | (mm) | | | | | |
| | Reinforcing | Material | PET | PET | PET | PET | |
| | layer | No. of | 1000de | 1000de | 1000de | 1000de | |
| | | denier | | | | | |
| | | No. of | 3 parallel | 3 parallel | 3 parallel | 3 parallel | |
| | | yarns | yarns × 48 | yarns × 48 | yarns × 48 | yarns × 48 | |
| | | | carriers | carriers | carriers | carriers | |
| | | Braid | 53 | 55 | 57 | 57 | |
| | | angle(°) | | | | | |
| | | Braid | 91 | 95 | 100 | 100 | |
| | | density | | | | | |
| | | (%) | | | | | |
| | Outer | Material | EPM | EPM | EPM | EPM | |
| | surface | Wall | 1.0 | 1.0 | 1.0 | 1.0 | |
| | layer | thickness | | | | | |
| | | (mm) | | | | | |
| Swaged | Dimension | Inner | diameter | diameter | diameter | diameter | |
| portion | (mm) | diameter | 10.0 | 12.0 | 10.0 | 12.0 | |
| of hose | | Outer | diameter | diameter | diameter | diameter | |
| body | | diameter | 16.6 | 17.9 | 16.6 | 17.9 | |
| | Inner | Wall | 1.9 | 1.6 | 1.9 | 1.6 | |
| | surface | thickness | | | | | |
| | layer | (mm) | | | | | |
| | Reinforcing | Braid | 55 | 60 | 59 | 62 | |
| | layer | angle (°) | | | | | |
| | Outer | Wall | 1.0 | 0.9 | 1.0 | 0.9 | |
| | surface | thickness | | | | | |
| | layer | (mm) | | | | | |
| Diametrically enlarging rate (%) | | | 11 | 33 | 11 | 33 | |
| Joint fitting pull-out force (kN) | | | 3.3 | 4.2 | 4.0 | 4.3 | |
| Bursting pressure at | | | 13.2 | 13.7 | 14.4 | 14.6 | |
| high temperature | | Mode of | Thread | Thread | Thread | Thread | |
| (MPa) | | disruption | breakage, | breakage, | breakage, | breakage, | |
| | | | disruption | disruption | disruption | disruption | |
| | | | at main | at root | at root | at root | |
| | | | portion | part of | part of | part of | |
| | | | of hose | swaged | swaged | swaged | |
| | | | body | portion of | portion of | portion of | |
| | | | | hose body | hose body | hose body | |
| Length change under pressure | | | −1.8 | 0.4 | 1.7 | 1.8 | |
| exerted (%) | | | | | | | |
| Insertability of mandrel when | | | ∘ | ∘ | ∘ | Δ | |
| diametrically enlarged | | | | | | | |
| | | | Comparative Examples | | | | |
| | | | A | B | C | D | |
| Main | Dimension | Inner | diameter | diameter | diameter | diameter | |
| portion | (mm) | diameter | 9.0 | 9.0 | 9.0 | 9.0 | |
| of hose | | Outer | diameter | diameter | diameter | diameter | |
| body | | diameter | 16.0 | 16.0 | 16.0 | 16.0 | |
| | Inner | Material | Cl-IIR | Cl-IIR | Cl-IIR | Cl-IIR | |
| | surface | Wall | 2.0 | 2.0 | 2.0 | 2.0 | |
| | layer | thickness | | | | | |
| | | (mm) | | | | | |
| | Reinforcing | Material | PET | PET | PET | PET | |
| | layer | No. of | 1000de | 1000de | 1000de | 1000de | |
| | | denier | | | | | |
| | | No. of | 3 parallel | 3 parallel | 3 parallel | 3 parallel | |
| | | yarns | yarns × 48 | yarns × 48 | yarns × 48 | yarns × 48 | |
| | | | carriers | carriers | carriers | carriers | |
| | | Braid | 57 | 45 | 50 | 60 | 53°< or |
| | | angle(°) | | | | | =74 _{1< or} |
| | | | | | | | =57° |
| | | Braid | 100 | 77 | 85 | 100 | |
| | | density | | | | | |
| | | (%) | | | | | |
| | Outer | Material | EPM | EPM | EPM | EPM | |
| | surface | Wall | 1.0 | 1.0 | 1.0 | 1.0 | |
| | layer | thickness | | | | | |
| | | (mm) | | | | | |
| Swaged | Dimension | Inner | diameter | diameter | diameter | diameter | |
| portion | (mm) | diameter | 12.5 | 12.0 | 12.0 | 12.0 | |
| of hose | | Outer | diameter | diameter | diameter | diameter | |
| body | | diameter | (18.2) | 17.9 | 17.9 | 17.9 | |
| | Inner | Wall | (1.6) | 1.6 | 1.6 | 1.6 | |
| | surface | thickness | | | | | |
| | layer | (mm) | | | | | |
| | Reinforcing | Braid | (64) | 50 | 55 | 62 | 53°<θ₂ |
| | layer | angle (°) | | | | | < or = |
| | | | | | | | 62° |
| | Outer | Wall | (0.9) | 0.9 | 0.9 | 0.9 | |
| | surface | thickness | | | | | |
| | layer | (mm) | | | | | |

| Diametrically enlarging rate (%) | | 39 | 33 | 33 | 33 | Target |
|---|---|---|---|---|---|---|
| Joint fitting pull-out force (kN) | | — | 2.7 | 3.2 | 4.6 | 3 kN or |
| | | | | | | above |
| Bursting pressure at | | — | 8.9 | 11.9 | 14.8 | 9.8 |
| high temperature | Mode of | — | Pinhole | Thread | Thread | Joint |
| (MPa) | disruption | | at main | breakage, | breakage, | fitting |
| | | | portion | disruption | disruption | not fallen |
| | | | of hose | at main | at root | out, no |
| | | | body | portion of | part of | pinhole |
| | | | | hose body | swaged | created |
| | | | | | portion of | at swaged |
| | | | | | hose body | portion |

| Length change under pressure | | −3.2 | −2.5 | 2.3 | ±2% |
|---|---|---|---|---|---|
| exerted (%) | | | | | |
| Insertability of mandrel when | x | ∘ | ∘ | x | ∘ or Δ |
| diametrically enlarged | | | | | |
| Note: | | | | | |
| *1) Braid density: Yarn area ratio to an outer surface area of inner surface rubber layer. Braid density = (yarn width × No. of yarns/(2 × π × outer diameter of an inner surface rubber layer × cos braid angle)) × 100 | | | | | |
| *2) In comparison example D, the reinforcing layer has a braid density over 100%. Here, as a wire member (reinforcing yarn) is arranged without space, the braid density is indicated as 100%. | | | | | |
| *3) Values in parentheses indicate calculated values. | | | | | |
| *4) In the line “Insertability of mandrel when diametrically enlarged”, a mark “x” indicates that the mandrel cannot be inserted in a hose body or unvulcanized hose body, and the hose body is crashed (buckled) in a longitudinal direction (unacceptable), a mark “Δ” indicates that the mandrel can be inserted, but tightly, and for example, the hose body or an inner surface of the hose body is scratched by a jig or the mandrel (acceptable), and a mark | | | | | |
| # “o” indicates that the mandrel is favorably inserted in the hose body (good). | | | | | |

As seen from the results shown in Table 1, the comparison example B includes a reinforcing layer where a braid angle of a reinforcing yarn at a main portion of a hose body is 45°, which is below the lower limit of the present invention, and a braid angle of the reinforcing yarn at a swaged portion thereof is 50°, which is below the lower limit of the present invention, 53°. Therefore, in the comparison example B, a value of the length change under pressure exerted exceeds a target range, and the swaging property such as the joint fitting pull-out force and the bursting pressure at high temperature is also inferior.

The comparison example C includes a reinforcing layer where a braid angle of a reinforcing yarn at a swaged portion of a hose body is 55°, which meets the requirement of the present invention, but a braid angle of the reinforcing yarn at a main portion thereof is 50°, which is below the lower limit of the present invention. Therefore, in the comparison example C, a value of the length change under pressure exerted exceeds the target range.

And, the comparison example D includes a reinforcing layer where a braid angle of a reinforcing yarn at a main portion of a hose body is 60°, which is above the upper limit of the present invention, and a braid angle of the reinforcing yarn at a swaged portion thereof is 65°, which is as high as above the upper limit of the present invention. Therefore, in the comparison example D, the swaging property is good, but a value of the length change under pressure exerted exceeds the target range. Further, the mandrel may be managed to be inserted, but it is hard to be diametrically enlarged, resulting in inferior or unacceptable insertability of mandrel.

On the contrary, all of the examples 1, 2, 3 and 4 exhibit favorable swaging property, favorable length change under pressure exerted, and favorable insertability of mandrel.

Meanwhile, the comparison example A is subject to a larger diametrically enlarging rate compared to the example 4. Thus, a braid angle of the reinforcing yarn at the swaged portion of the comparison example A becomes 64°, higher than 62° to accordingly. So, the example 4 exhibits favorable or acceptable insertability of mandrel, while the comparison example A exhibits inferior or unacceptable insertability of mandrel.

As understood from the above results, the braid angle of the reinforcing yarn at the swaged portion is preferably limited 62° at maximum in view of insertability of mandrel. In other words, it is understood that favorable (good or acceptable) insertability of mandrel may be secured by limiting a braid angle 62° at maximum.

And, as apparent from the comparison of the results of the example 1, 3 with those of the examples 2, 4, it is understood that the swaging property (joint fitting pull-out force) is improved when the reinforcing layer has higher braid angle of the reinforcing yarn at the swaged portion.

Although the preferred embodiments have been described above, this is only one of embodiments of the present invention. The present invention may be constructed and embodied in various configurations and modes within the scope of the present invention.

We claim:

1. A high-pressure resistant vibration absorbing hose, comprising:
a hose body having an inner surface layer, a reinforcing layer formed on an outer side of the inner surface layer by braiding or spirally winding a reinforcing wire member and an outer surface layer as a cover layer on an outer side of the reinforcing layer, the reinforcing layer having a high braid or winding density of the reinforcing wire member of 50% or more, the hose body having a swaged portion on an axial end portion of the hose body and a main portion other than the swaged portion,
a joint fitting attached to the swaged portion of the hose body, the joint fitting having a rigid insert pipe and a sleeve-like socket fitting, the joint fitting being securely fixed to the swaged portion by securely swaging the socket fitting to the swaged portion in a diametrically contracting direction while the insert pipe is inserted within the swaged portion and the socket fitting is fitted on an outer surface of the swaged portion, a bursting pressure of the high-pressure resistant vibration absorbing hose being 5 MPa or more,
the swaged portion of the hose body being made to have an enlarged diameter than the main portion of the hose body in a state before the joint fitting is securely swaged to the swaged portion, and
the reinforcing layer having a braid or winding angle of the reinforcing wire member in a range from 53° to 57° at a position of the main portion, and in a range of above 53° to 62° at a position of the swaged portion of the enlarged diameter.

2. The high-pressure resistant vibration absorbing hose as set forth in claim 1, wherein the reinforcing layer having a braid or winding angle of the reinforcing wire member in a range of above a neutral angle to 62° at a position of the swaged portion of the enlarged diameter.

3. A method for producing the high-pressure resistant vibration absorbing hose as defined in claim 1, comprising:
(a) a step of forming an hose body laminated with an inner surface rubber layer as the inner surface layer, the reinforcing layer formed by braiding or spirally winding the reinforcing wire member at a braid or winding angle in a range of 53° to 57° and an outer surface rubber layer as the outer surface layer,
(b) a step of diametrically enlarging an axial end portion of the hose body by force fitting a mandrel therein, and thereby increasing the braid or winding angle of the reinforcing wire member in the reinforcing layer within a range of above 53° to 62° at the axial end portion, and
(c) a step of heating the hose body while maintaining the axial end portion of the hose body in a diametrically enlarged state.

4. The method for producing the high-pressure resistant vibration absorbing hose as set forth in claim 3, wherein the braid or winding angle of the reinforcing wire member in the reinforcing layer is increased within a range of above a neutral angle to 62° at the axial end portion in the step of (b).

5. The method for producing the high-pressure resistant vibration absorbing hose as set forth in claim 3, the mandrel is force fitted in the axial end portion of the hose body in which the outer surface of the main portion is retained and restrained by a retaining member, so as to diametrically enlarge the axial end portion.

6. The method for producing the high-pressure resistant vibration absorbing hose as set forth in claim 5, wherein the mandrel is force fitted inside the axial end portion of the hose body while an internal pressure is exerted in the hose body.
